(19) United States
(12) Patent Application Publication
(10) Pub. No.: US 2007/0120970 A1
(43) Pub. Date: May 31, 2007

(54) Video telephony device having automatic user detection and recognition capabilities to provide user-specific information

(76) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/274,078

(22) Filed: Nov. 15, 2005

(51) Int. Cl. H04N 7/14

(52) U.S. Cl. 348/14.16

(57) ABSTRACT

A method and apparatus is provided for presenting a user with customized access to a video telephony device. The method begins by acquiring a first representation of the face of an individual who comes within view of a camera associated with the video telephony device. The first acquired representation is compared to stored facial representations of individuals who previously registered as users with the video telephony device. If a match is found between the first acquired representation and a stored representation of a given individual, a database is accessed containing user defined information (e.g., a personal phonebook). The given individual is then presented with access to the device in accordance with the user defined information.

### FIELD OF THE INVENTION

The present invention relates generally to video telephony devices and more particularly to a video telephony device that provides to registered users who are visually identified by the device customized access to a user specific database that may include a personal phonebook, personal graphical user interface (GUI), alerts, screensavers, and the like

### BACKGROUND OF THE INVENTION

Many conventional telephones have an electronic phone book capability, which stores names, telephone numbers, and other personal information so that they can be accessed as needed. This phone-book capability can allow a user to make a telephone call without searching another medium, such as a printed phone directory or an address book. Additionally, when a call arrives, it is possible to compare the caller number informed by the caller with the data registered in the phone book and display the corresponding name so that the user can know who the caller is before answering the call.

Video telephones are available that are capable of handling image information. Such video telephones transmit and receive voice and image data simultaneously so that the calling and called parties can talk to each other while viewing the images sent from the opposite parties. The video telephone also may be able to record an image received while talking or record an image that is taken by a camera incorporated into the video telephone. Recorded image data associated with a caller may in some cases also be stored in the electronic phone book. When a user accesses the phone book to place a call, this capability can permit the user to conduct a search while viewing image information. On the other hand, when a call is received, this capability can allow the image information to be displayed together with name information, helping the user immediately identify the caller.

Conventional telephones, with or without video capability, are generally used by a number of different individuals. For example, telephones located in a residence are usually accessed by various family members. The electronic phone book associated with such telephones, however, is generally a single common phone book for the entire household. Because of the complexity of presenting user-specific information, telephones typically do not provide personal phonebooks or other information and preferences for each and every user.

### BRIEF DESCRIPTION OF THE DRAWINGS

FIG. 1 shows a functional block diagram a video telephony device.

FIG. 2 is a flowchart showing an illustrative method by which the video telephony device in FIG. 1 can detect and recognize a user in order to provide the user with his or her own phonebook and other preferences.

FIG. 3 shows an illustrative representation of the information database.

FIG. 4 shows a flow chart of this process by which the video telephony device enters an active state from a sleep mode.

FIG. 5 is a flowchart showing an initialization process that may be employed when a new user registers for the first time or when an existing user wishes to edit his or user profile by revising the data in the user database.

### DETAILED DESCRIPTION

Conventional video telephones or other telephony devices offer a user-facing camera that has not been previously employed to provide simplified access to and navigation through the telephone. Specifically, the sensor or camera of a video telephony device is not used to detect and recognize a user by taking an image of the user and the user's facial features as he or she approaches the device.

In the system and method described herein, image identification software such as facial feature software is used to compare features of the user to images stored in a database or lookup table of the video telephony device. If the software makes a match of the face with one stored in the database, the user will be presented with his or her personal information such as a personal phonebook. In addition, the device also may be automatically adjusted in accordance with any personal preferences of the identified user such as a personally configured user interface. In this way, for instance, the user will not be required to navigate through a complicated menu of choices before retrieving his or her information and preferences. Depending on the features and functionality offered by the video telephony device, the personal information and/or preferences may include such things as a personal phonebook, a personally configured graphical user interface (GUI), alerts, screensavers, and the like. Other personal information that may be made available includes call logs, buddy lists, journals, blogs, and web sites.

In addition to presenting the user with personal information and preferences, other menus may be offered to the user that allow customization of various features and settings. For example, such menus may include a restriction menu, a settings menu and a control and action menu. The restriction menu allows the user to impose on other users restrictions on usage of the video telephony device. For example, a parent may wish to provide control restrictions on children who also may be users of the video telephony device. For instance, a parent may not want a child to place calls after 6 pm on weeknights (except for emergency numbers such as 911). Also, a resident may wish to prevent guests (unregistered users) from placing long distance calls. The settings menu allows the user to customize various characteristics of the video telephony device that impact the individual user's interaction with the device, such as the volume and screen brightness, for example. Each user can establish and customize his or her own settings. The control and action menu allows each user to enter new data (e.g., a new phonebook entry) or edit old entries. In some cases the control and action menu may be a part of the device's operating system.

In general, personal information that is made available may be information that is directly associated with the user such as phonebook entries. In addition, as previously mentioned, the information may be restrictions or the like that are imposed on the user and thus are indirectly associated with the user. For instance, if a child's (the user) usage is restricted by entries in the restrictions menu that has been established by a parent (another user), then the restriction menu is information that is indirectly associated with the user.

At the outset, it should be noted that the features and functionality discussed herein may be embodied in a video telephony device that can transmit and receive information over any of a variety of different external communication media supporting any type of service, including voice over broadband (VoBB) and legacy services. VoBB is defined herein to include voice over cable modem (VoCM), voice over DSL (VoDSL), voice over Internet protocol (VoIP), fixed wireless access (FWA), fiber to the home (FTTH), and voice over ATM (VoATM). Legacy services include the integrated service digital network (ISDN), plain old telephone service (POTS), cellular and 3G. Accordingly, the external communication medium may be a wireless network, a convention telephone network, a data network (e.g., the Internet), a cable modem system, a cellular network and the like.

Various industry standards have been evolving for video telephony services such as those promulgated by the International Telecommunications Union (ITU). The standards and protocols that are employed will depend on the external communication medium that is used to communicate the voice and audio information. For example, if the video telephony device employs a POTS service, protocols may be employed such as the CCITT H.261 specification for video compression and decompression and encoding and decoding, the CCITT H.221 specification for full duplex synchronized audio and motion video communication framing, the CCITT H.242 specification for call setup and disconnect. On the other hand, video telephony devices operating over the Internet can use protocols embodied in video conference standards such as H.323 as well as H.263 and H.264 for video encoding and G.723.1, G.711 and G.729 for audio encoding. Of course, any other appropriate standards and protocols may be employed. For example, IETF standards such as SIP, RTP/RTCP protocols may be employed.

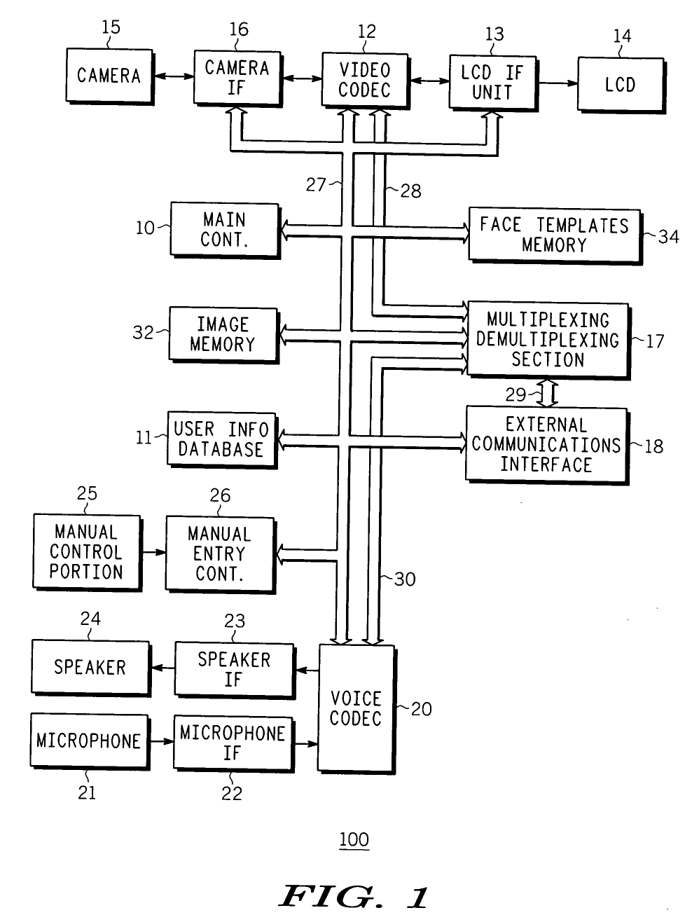

FIG. 1 shows a functional block diagram of a video telephony device 100. The functional elements depicted in FIG. 1 are applicable across the various telephony platforms and protocols mentioned above. That is, the video telephony device 100 may be, without limitation, an analog phone, ISDN phone, analog cellular phone, digital cellular phone, PHS phone, Internet telephone and so on. Of course, the implementation of each functional element and the standards and protocols employed will differ from platform to platform. The device comprises a main controller 10, a personalized user information database 11, an image memory 32, a face template memory 34, a video codec 12, an display interface 13, a display unit 14 such as an LCD, a camera portion 15, a camera interface 16, a multiplexing and separating section 17, an external communications interface 18, a voice codec 20, a microphone 21, a microphone interface 22, a speaker interface 23, a speaker 24, a manual control portion 25, and a manual entry control circuit portion 26. The manual control portion 25 may be, for example, a telephone handset and/or other user interface components (e.g., a touchscreen) that allow the user to properly use the video telephony device 100.

Of these components, the main controller 10, the personalized user interface database 11, the image memory 32, the video codec 12, the LCD interface 13, the camera interface 16, the multiplexing and separating section 17, the communications interface 18, the voice codec 20, and the manual entry control circuit portion 26 are connected together via a main bus 27.

The multiplexing and separating section 17, which manages the incoming and outgoing video and audio data to and from the external communications network, is connected with the video codec 12, the communications system interface 18, and the voice codec 20 via sync buses 28, 29, and 30, respectively. The main controller 10 includes a CPU, a ROM, a RAM, and so on. The operations of the various portions of the video telephony device are under control of the main controller 10. The main controller 10 performs various functions in software according to data stored in the ROM, RAM, personalized user information database 11, image memory 32 and face template memory 34.

The personalized user information database 11 is used to store a database of information for each registered user. Each database is composed of plural records. Each record may comprise, for instance, a personal phonebook (including, e.g., a phone book memory number, a phone number, a name, various addresses and any other appropriate information such as typically found in a contact list), a personally configured graphical user interface (GUI) for display on display unit 14, and/or alerts, screensavers, call logs, buddy lists, journals, blogs, and web sites or other preferences. When retrieved, the personal phonebook may be presented to the user on the display unit 14.

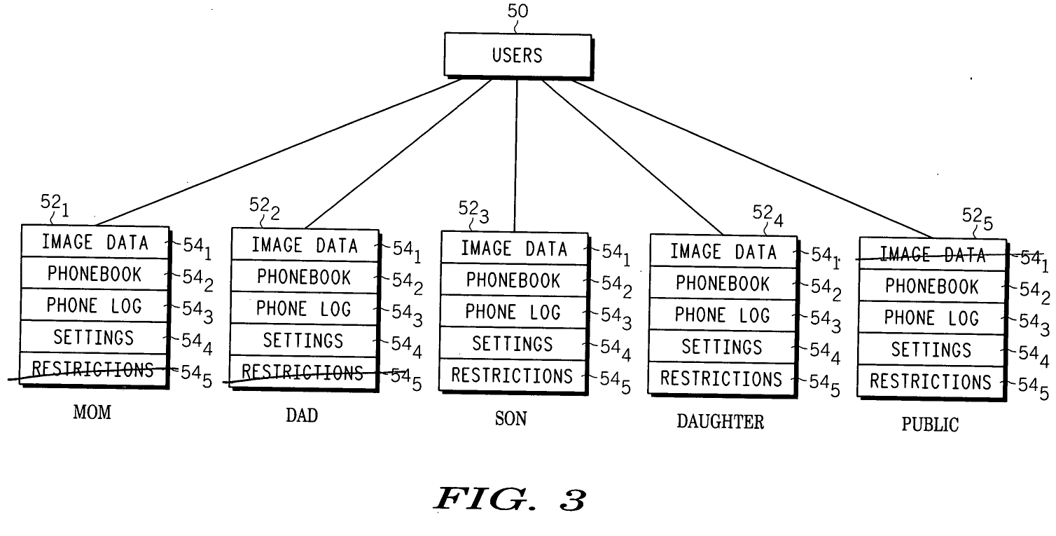

FIG. 3 shows an illustrative representation of information database 11 indicating how the information may be structured and linked together. While the information database 11 is shown having a tree structure, any other appropriate arrangement may be employed to link together the data stored in information database 11. The database includes a folder of users 50, each of whom in turn has their own folder. For instance, in FIG. 3, the user folders 52₁-52₅ are shown for a family of four and include a folder for mom (folder 52₁), dad (folder 52₂), son (folder 52₃), daughter (folder 52₄), as well as a public folder (52₄) for other users such as guests and visitors. Each of the user folders 52 is linked to a series of records 54 in which the information associated with each user is stored. For example, in FIG. 3, illustrative user records include records for image data 54₁, phonebook 54₂, phone log 54₃, phone settings 54₄, and restrictions and authentication credentials 54₅.

The user folders 52₁-52₅ may or may not include all the same record fields. For instance, it generally will not be necessary for the mom and dad folders to include the restrictions record. Alternatively, the restrictions record may be present in the mom and dad folders, but they may simply remain unpopulated. On the other hand, the public folder 52₄ will not need the image data record 54, and thus, as shown in FIG. 3, this record may not be available or present.

The video codec 12 decodes and reproduces encoded video data, and sends the reproduced video data to the display interface 13. Furthermore, the video codec 12 encodes video data supplied from the camera portion 15 via the camera interface 16 and creates video data encoded in accordance with e.g., MPEG-4.

The display interface 13 converts the video data supplied from the video codec 12 into a signal form that can be processed by the display 14, and sends the converted data to the display 14. The display 14 may be, for example, a color or monochrome liquid crystal display having sufficient video displaying capabilities (such as resolution) to display video with MPEG-4, and displays a picture according to video data supplied from the display interface 13.

For example, a CCD or CMOS camera may be used as the camera 15, which picks up an image of an object, creates video data, and sends it to the camera interface 16. The camera interface 16 receives the video data from the camera 15, converts the data into a form that can be processed by the video codec 12, and supplies the data to the codec 12.

The multiplexing and separating portion 17 is responsible for managing the incoming and outgoing video and audio data to and from the external communications network via communications system interface 18. Specifically, multiplexing and separating portion multiplexes encoded video data supplied from the video codec 12 via the sync bus 28, the encoded audio data supplied from the voice codec 20 via the sync bus 30, and other data supplied from the main controller 10 via the main bus by a given method (e.g., H.221). The multiplexing and demultiplexing portion 17 supplies the multiplexed data as transmitted data to the external communications interface 18 via the sync bus 29.

The multiplexing and demultiplexing portion 17 demultiplexes encoded video data, encoded audio data, and other data from the transmitted data supplied from the communications interface 18 via the sync bus 29. The multiplexing and demultiplexing portion 17 supplies the demultiplexed data to the video codec 12, the voice codec 20, and the main controller 10, respectively, via the sync buses 28, 30, and the main bus 27.

The external communications interface 18 is used to make a connection to the external communications network, which, as previously mentioned, may be any suitable network such as, but not limited to, a wireless network, a conventional telephone network, a data network (e.g., the Internet), and a cable modem system. The interface 18 makes various calls for communications via the communications network and sends and receives voice and video data via communications paths established in the network.

The voice codec 20 digitizes analog audio signal applied via the microphone 21 and the microphone interface. The codec 20 encodes the signal by a given audio encoding method such as ADPCM to create encoded audio data, and sends the encoded audio data to the multiplexing and demultiplexing portion 17 via the sync bus 30.

The voice codec 20 decodes the encoded audio data supplied from the multiplexing and demultiplexing portion 17 into an analog audio signal, which is supplied to the speaker interface 23.

The microphone 21 converts sound from the surroundings into an audio signal and supplies it to the microphone interface 22, which in turn converts the audio signal supplied from the microphone 21 into a signal form that can be processed by the voice codec 20 and supplies it to the voice codec 20.

The speaker interface 23 converts the audio signal supplied from the voice codec 20 into a signal form capable of being processed by the speaker 24, and supplies the converted signal to the speaker 24. The speaker 24 converts the audio signal supplied from the speaker interface 23 into an audible signal at an increased level.

The manual control portion 25 receives various instructions of the user to be applied to the main controller 10. The manual control portion 25 has control buttons for specifying various functions, push buttons for entering phone numbers and various numerical values, and a power switch for turning on and off the operation of the present terminal. The manual entry control circuit portion 26 recognizes the contents of an instruction entered from the manual control portion 25 and informs the main controller 10 of the contents of the instruction.

Image memory 32 stores (at least on a temporary basis) one or more facial images of each individual who will be using the video telephony device 100. Prior to use, a registration process will be performed in which these individuals will have their images captured by camera 15 and stored in image memory 32. The images will be associated with the names of each individual, which may be entered manually via the manual control portion 25. The stored images of each individual are converted to a facial representation or template. The representation or template may correspond to an image or simply a set of points and vectors between them identifying selected features of the face. Alternatively, the representation may be a single parameter corresponding to something as simple as eye color or the distance between the individual's eyes. These representations or templates are stored in face templates memory 34. Once the representations or templates have been obtained, the images stored in image memory may be deleted. If desired, image memory 32 and face templates memory 34 may be implemented as part of the memory 120 incorporated in main controller 10. This memory may also store an image recognition software program, discussed below.

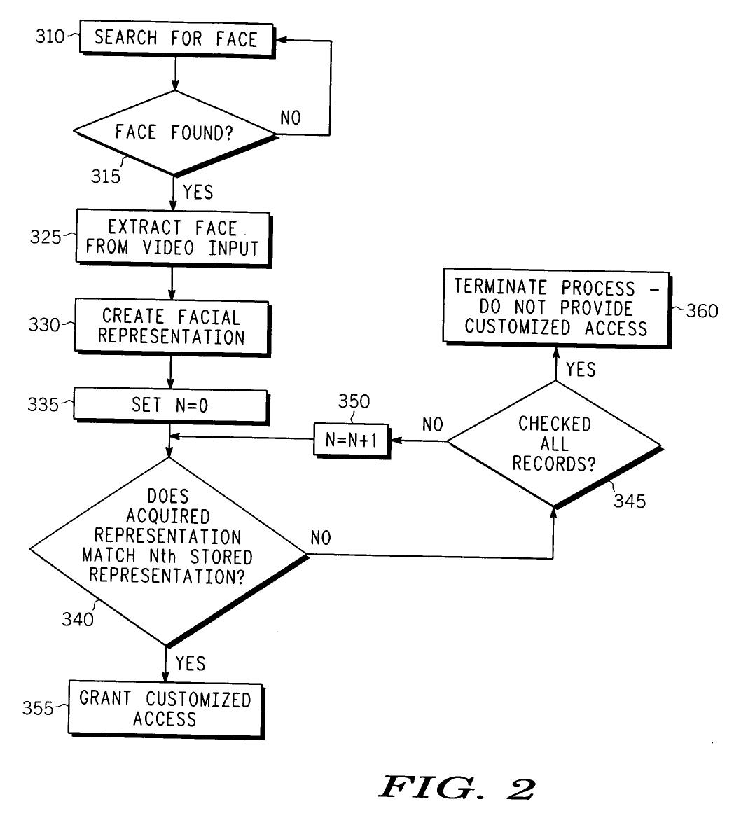

FIG. 2 is a flowchart showing a method by which the video telephony device can detect and recognize a user in order to provide the user with his or her own personal information and/or other preferences. Such detection and recognition uses the camera 15 that is already present in the video telephony device to acquire visual biometric data such as facial features that uniquely identify the user. Various software is known in the art that processes data from video data patterns received from an object being analyzed, and determines whether the object has a face. For example, commercially available software includes the Visionics Face-It software, well known to those skilled in the art. Another such program is the C++ function CHead::FindHeadPosition of the FaceIt Developer Kit. It is stressed that the present invention is not limited to any particular facial feature mapping function, but can include any known algorithm, suitable for the purposes described herein, for recognizing facial features, whether it be two-dimensional or three-dimensional.

In steps 310-315 of the flowchart of FIG. 2, the video telephony device 100 repeatedly searches for a human face in the field of view of camera 15. Thus, in step 310 the system searches the field of view of camera 15 to determine whether it contains a human face. If a face is not detected in step 310, decision step 315 fails and the system returns to step 310 to continue searching for a face in the field of view of video camera 15.

If a face is detected in step 310 (e.g., if individual approaches the video telephony device and thus enters the field of view of camera 15), decision step 315 succeeds and constructs a face template of the detected face. Thus, in step 325 the system extracts the detected face from the video signal provided by camera 15. The system proceeds to step 330 where it converts the facial image into a facial representation or template that is temporarily stored in memory.

At this point, the system attempts to match the acquired facial representation against the facial representations of the N individuals stored in face template memory 34. As shown in FIG. 2, steps 335-350 comprise a loop which successively compares the acquired representation with each of the stored representations of registered individuals until a match is found or until all of the stored representations have been examined. As noted above, the stored representations are generated from the images of authorized individuals stored in image memory 32 and maintained in face templates memory 34. The loop begins by setting N equal to zero in step 335 and then in step 350 successively incrementing N to examine each of the N records.

Continuing with FIG. 2, if no match is found in steps 335-350, the process terminates in step 360 without providing any customized access since the individual is presumably not registered. If, on the other hand, a match is found, decision step 340 succeeds and the individual in the field of view of video camera 15 is granted access to video telephony device 100 in step 355 in a customized manner. In one case, this customized grant of access simply comprises accessing a personal phonebook associated with the individual from personalized user information database 11. In other cases, the grant of access may also include access to other personal information stored in memory such as previously received and previously dialed call history logs, for example. In addition the grant of access may include the establishment of various personal preferences such as whether call waiting is enabled or disabled, the adjustment of volume and other setting, the appearance of the home screen on the display 14 and the arrangement and operation of the menu that appears on display 14. In yet other cases where security is an issue, the customized grant of access may even include the ability to place or receive telephone calls and/or activate parental control restrictions. That is, the video telephony device may be disabled for all but previously authorized users.

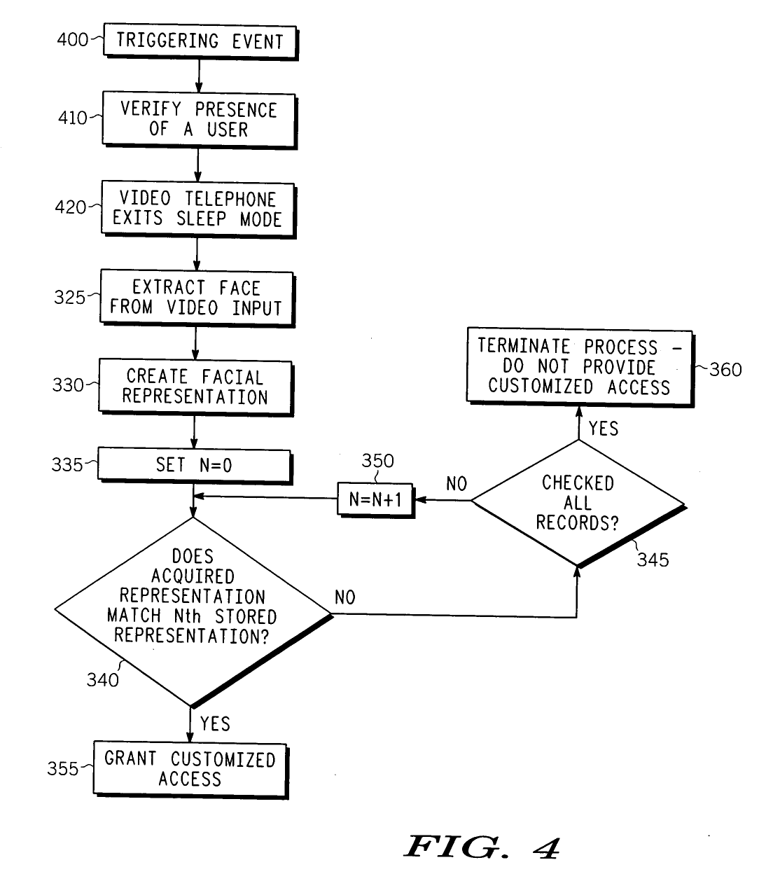

In one alternative, instead of performing the continuous loop established by steps 310 and 315 in which the video telephony device repeatedly searches for a face, the camera may be used as a proximity detector to determine when a face has come within some predetermined distance (e.g., 2 feet) of the telephony device. In this case the telephony device may remain in a sleep mode until the triggering event (e.g., detection of a face) occurs, at which an point an interrupt is sent to the controller 10 (or a software event generated) requesting it to begin the registration process. In the sleep mode the video telephony device may power down or place in a standby mode a variety of different components including, for example, the display 14, the camera portion 15, and the main controller 10. In some cases the video telephony device may incorporate a dedicated sensor that serves as the proximity detector instead of the camera. For example, a heat sensor, motion detector or like may be used as a proximity detector to determine when a triggering event (e.g., detection of motion, detection of body temperature) has occurred that is indicative of the presence of an individual who is ready to use the telephony device. FIG. 4 shows a flow chart of this process by which the video telephony device enters an active state from a sleep mode. First, in step 400 a triggering event is detected by the camera or other proximity detector. In step 410 the telephony device verifies that in fact a user is present. If step 400 is performed by a proximity detector other than the camera, step 410 may be, for example, a confirmation step in which the camera acquires an image to verify that a face is indeed present. Finally, in step 420, the video telephony device exits the sleep mode, after which the device may continue the registration process with step 325 in FIG. 2.

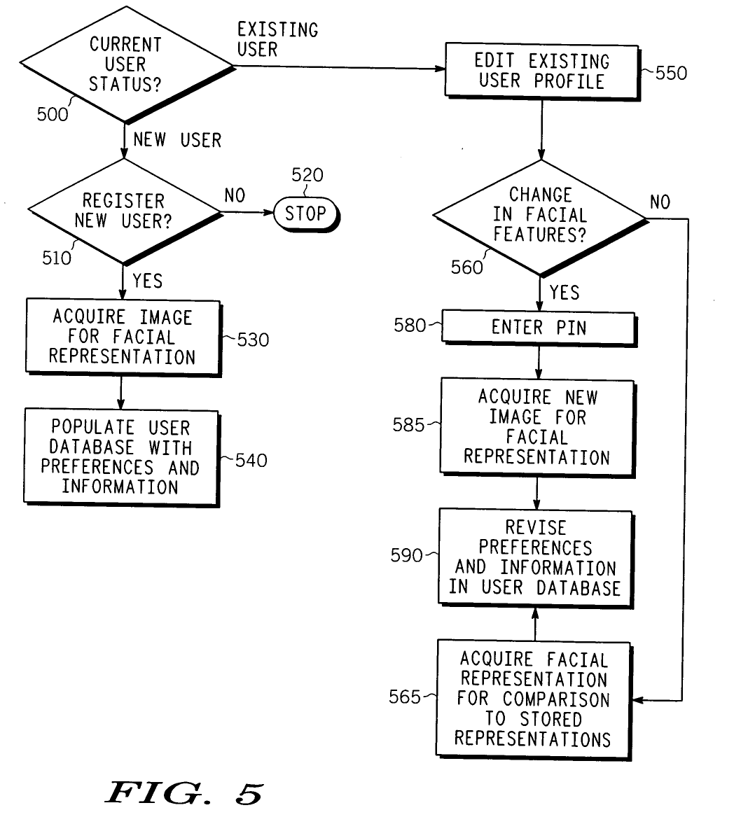

FIG. 5 is a flowchart showing an initialization process that may be employed when a new user registers for the first time or when an existing user wishes to edit his or her profile by revising the data in user database 11. The process may begin, for example, when the user is presented with menu options on the display after the device exits sleep mode. The menu options may request the user to specify whether a new user is to register, whether an existing user database is be edited, or if the registration process should be allowed to continue as in FIG. 2 for an already existing user. Alternatively, the initialization process may begin by some other means, such as with the use of a dedicated initialization button on the manual control portion 25 of the telephony device. In any case, the initialization process begins in step 500 with a query requesting the current user status. If the user is a new user, then the process continues in step 510, in which the user is asked if he or should would like to register as a new user. If no, then the initialization process terminates in step 520. If the user does wish to register, the process continues in step 530 by acquiring a facial representation or template for storage in face template memory 34. Next, once the telephony device has stored to facial representation of the new user, the new user is asked in step 540 to populate the various records in user database 11 with the user's preferences and information, which may include a PIN number or other entry as an alternative form of identification. In some cases the records may be automatically populated using any information that is available to the video telephony device itself without user intervention. For instance, the name of the called party may be automatically stored using the caller ID feature, if available.

Returning to step 500, if instead of registering a new user, the user specifies that he or she is an existing user, the process continues with step 550 instead of step 510. In step 550 the user confirms that he or she wants to revise the preferences and information stored in the user database 11. Preliminarily, in step 560, the user is asked if he or she has had a change in facial features that may be sufficient to prevent recognition as an existing user. That is, a query could be presented to the user along the lines of “Do you want to re-initialize the phone so that it will recognize your current appearance or look?” For example, the user may have recently grown or shaved a beard or began wearing glasses, which could interfere with the recognition process. In this case the user is requested in step 580 to enter a PIN or other personal identifier that may be used as an alternative form of identification and which has been previously stored in user database 11. Once the user has been so recognized, a new image of the user is obtained in step 585, from which is extracted a new facial representation or template that is stored in face template memory 34 (either replacing or supplementing the currently stored facial representation or template), after which the process continues with step 590. On the other hand, if in response to the query of step 560 the user indicates in step 570 that there has been no change in facial features, the process proceeds to step 565 in which a facial representation is acquired for comparison to the stored representations of registered users, after which the process proceeds to step 590. In step 590, the user is presented with the opportunity to edit and revise his or her various records stored in user database 11.

Although various embodiments are specifically illustrated and described herein, it will be appreciated that modifications and variations of the present invention are covered by the above teachings and are within the purview of the appended claims without departing from the spirit and intended scope of the invention. For example, while the above systems and methods have been described in terms of a video telephony device that resides in or on a fixed location such as desk, the systems and methods could also be used in a cellphone or other mobile phone environment.

1. A method of presenting a user with customized access to a video telephony device, comprising:
acquiring a first representation of the face of an individual who comes within view of a camera associated with the video telephony device;
comparing the first acquired representation to stored facial representations of individuals who previously registered as users with the video telephony device;
if a match is found between the first acquired representation and a stored representation of a given individual, accessing a database containing user defined information; and
presenting the given individual with access in accordance with the user defined information.

2. The method of claim 1 wherein said user defined information comprises a personal phonebook.

3. The method of claim 1 wherein user defined information comprises personal information and/or preferences.

4. The method of claim 1 wherein user defined information comprises control and administrative information.

5. The method of claim 1 wherein said user defined information comprises a personally configured graphical user interface (GUI).

6. The method of claim 1 wherein said user defined information comprises at least one item selected from the group consisting of alerts, screensavers call logs, buddy lists, journals, blogs, and web sites.

7. The method of claim 1 wherein, if a match is found, further comprising the step of configuring the video telephony device in accordance with at least one preferred setting of the given individual.

8. The method of claim 2 wherein said personal phonebook is presented to the given individual on a display of the video telephony device.

9. The method of claim 1 wherein if no match is found between the first acquired representation and any of the stored representations, preventing the individual from accessing the user defined information.

10. The method of claim 9 wherein if no match is found between the first acquired representation and any of the stored representations, preventing the individual placing one of a subset of calls.

11. At least one computer-readable medium encoded with instructions which, when executed by a processor, performs a method including:
acquiring a first representation of the face of an individual who comes within view of a camera associated with a video telephony device;
comparing the first acquired representation to stored facial representations of individuals who previously registered as users with the video telephony device;
if a match is found between the first acquired representation and a stored representation of a given individual, accessing a database containing user defined information; and
presenting the given individual with access in accordance with said user defined information.

12. The computer-readable medium of claim 11 wherein said user defined information comprises a personal phonebook.

13. The computer-readable medium of claim 11 wherein user defined information comprises personal information and/or preferences.

14. The computer-readable medium of claim 11 wherein user defined information comprises control and administrative information.

15. The computer-readable medium of claim 11 wherein said user defined information comprises a personally configured graphical user interface (GUI).

16. The computer-readable medium of claim 11 wherein said user defined information comprises at least one item selected from the group consisting of alerts, screensavers call logs, buddy lists, journals, blogs, and web sites.

17. An apparatus for communicating video and audio data over an external communication path, comprising:
a camera for capturing image data;
a memory capable of storing at least a representation of registered user images and user defined information associated with registered users; and
a processor for receiving the representation of the registered user images, comparing the representation of the registered users retrieved from the memory with additional image data captured by the camera, and accessing the user defined information.

18. The apparatus of claim 17 wherein said user defined information comprises a personal phonebook.

19. The apparatus of claim 17 wherein said user defined information comprises a personally configured graphical user interface (GUI).

20. The apparatus of claim 17 wherein said user defined information comprises at least one item selected from the group consisting of alerts, screensavers call logs, buddy lists, journals, blogs, and web sites.

21. The apparatus of claim 17 wherein said user defined information comprises control and administrative information.

22. The apparatus of claim 17 further comprising:
a video codec for encoding the image data received from the camera and decoding image data received over the external communication path; and
an audio codec for encoding audio data received from the camera and decoding audio data received over the external communication path.

23. At least one computer-readable medium encoded with instructions which, when executed by a processor, performs a method including:
identifying a triggering event representing an individual approaching a video telephony device;
acquiring an image to verify that an individual is approaching the video telephony device; and
if verified, instructing the video telephony device to enter an active mode of operation from an inactive mode of operation.

24. The computer-readable medium of claim 23 wherein the triggering event is visually identified by a camera incorporated in the video telephony device.

25. The computer-readable medium of claim 23 wherein the triggering event is visually identified by a proximity detector incorporated in the video telephony device.

26. The computer-readable medium of claim 25 wherein the proximity detector is selected from the group consisting of a heat sensor and a motion detector.

27. At least one computer-readable medium encoded with instructions which, when executed by a processor, performs a method including:
receiving a request to manipulate a user folder stored in a video telephony device; and
in response to the request, acquiring a representation of the face of the user.

28. The computer-readable medium of claim 27 further comprising changing data stored in at least one user folder.

29. The computer-readable medium of claim 28 wherein the changing of the data further comprises establishing a new user folder.

30. The computer-readable medium of claim 28 wherein the changing of the data further comprises editing an existing user folder.

31. The computer-readable medium of claim 30 wherein the editing of the existing user folder further comprises storing the acquired representation of the face over an existing representation of a face.

32. The computer-readable medium of claim 30 wherein the editing of the existing user folder further comprises editing at least one item selected from the group consisting of alerts, screensavers call logs, buddy lists, journals, blogs, and web sites.

33. The computer-readable medium of claim 27 further comprising storing the acquired representation in a memory associated with the video telephony device.
